(19) United States
(12) Patent Application Publication
(10) Pub. No.: US 2007/0058330 A1
(43) Pub. Date: Mar. 15, 2007

(54) A Slider Module with a Flipping Function

(75) Inventor: Yung-Kun Lin, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASUSTeK COMPUTER, INC., Taipei (TW)

(21) Appl. No.: 11/460,293

(22) Filed: Jul. 27, 2006

(30) Foreign Application Priority Data
Sep. 15, 2005 (TW) 94131923

(51) Int. Cl. G06F 1/16

(52) U.S. Cl. 361/681; 361/683

(57) ABSTRACT

A slider module with a flipping function includes a slide board, an end stopper, at least one protrusion and a slider assembly. The end stopper is mounted on one end of the slide board. The protrusion is mounted on the slide board. The slider assembly is coupled with the slide board. The slider assembly has at least one roller, at least one sheet spring, a slider, at least one rotation spring, and a rotation part. The roller is positioned on the inner surface of the protrusion. The sheet spring is mounted on the roller. The slider is mounted on the sheet spring. The rotation spring is mounted on the front end of the slider. The rotation part is mounted on the rotation spring.

### RELATED APPLICATIONS

The present application is based on, and claims priority from, Taiwan Application Serial Number 94131923, filed Sep. 15, 2005, the disclosure of which is hereby incorporated by reference herein in its entirety.

### BACKGROUND

1. Field of Invention

The present invention relates to a slider module. More particularly, the present invention relates to a slider module with a flipping function.

2. Description of Related Art

Digital products such as mobile phones and personal digital assistants never cease to be reinvented into trendy and appealing accessories. As the market becomes more and more competitive, mobile phone and PDA screens are becoming larger to entice consumers to buy them. Consequently, the number of buttons required to control these digital products is also increasing due to more functions being made available than in traditional products. Thus, the traditional candy-bar design is not spacious enough to contain the screen and the buttons of the modern digital products.

Clamshell and slide type mobile phones satisfy this need. The slide type mobile phones have a screen and a keyboard. The keyboard is positioned on the back of the screen and is able to be moved parallel to the screen.

However, the angle between the screen and the keyboard of these phones is about 18020 , which is not suitable because the phones cannot be hugged closely to the human face, causing sound to be received unclearly and mixed with much background noise. Moreover, users need to push the keyboard with both hands to open some of the slide type mobile phones, while others can be opened automatically but need complex and expensive mechanisms to do so.

For the foregoing reasons, there is a need for a slider module with a flipping function in a slide type mobile phone that enables an angle between the screen and keyboard suitable for a human face and can open automatically.

### SUMMARY

It is therefore an aspect of the present invention to provide a slider module with a flipping function, which employs spring mechanisms to make an angle between a screen and a keyboard of a slide type mobile phone suitable for a human face such that sound received by the slide type mobile phone is clear.

It is another aspect of the present invention to provide a slider module, which employs spring mechanisms to enable a slide type mobile phone to be opened easily.

In accordance with the foregoing and other aspects of the present invention, a embodiment of the a slider module with a flipping function including a slide board, an end stopper, at least one protrusion and a slider assembly is provided. The end stopper is mounted on one end of the slide board. The protrusion is mounted on the slide board. The slider assembly is coupled with the slide board. The slider assembly has at least one roller, at least one sheet spring, a slider, a rotation spring, and a rotation part. The roller is positioned on the inner surface of the protrusion. The sheet spring is mounted on the roller. The slider is mounted on the sheet spring. The rotation spring is mounted on the front end of the slider. The rotation part is mounted on the rotation spring.

The roller is moved to the apex of the protrusion such that the sheet spring is deformed to store energy when the slider is pushed from the other end of the slide board. The sheet spring releases the energy such that the slider is moved to the end stopper automatically and stopped by the end stopper when the slider is past the apex of the protrusion.

The rotation spring enables the rotation part to be rotated relative to the slider. The slide board limits the rotation of the rotation part when the slider assembly slides along the slide board. The rotation part is rotated relative to the slider while not limited by the slide board when the end stopper stops the slider such that the rotation part is protruded from the slide board.

According to one preferred embodiment of the invention, the protrusion may be a sheet spring structure for enhancing the energy, which is stored first and then released to move the slider assembly. The slide board further includes a pair of sidewalls mounted on both sides of the slide board. Each of the sidewalls has a glide groove in which the protrusion is mounted. The roller is also mounted in the glide groove whereby the roller can be rolled on the inner surface of the protrusion.

In accordance with another aspect of the invention, a slider module, which may be mounted in an electrical apparatus, is provided. The slider module includes a slide board, at least one protrusion and a slider assembly. The protrusion is mounted on the slide board. The slider assembly is coupled with the slide board. The slider assembly has at least one roller, at least one sheet spring and a slider. The roller is positioned on the inner surface of the protrusion. The sheet spring is mounted on the roller. The slider is mounted on the sheet spring.

The roller is moved to the apex of the protrusion such that the sheet spring is deformed to store energy when the slider is pushed from one end of the slide board. The sheet spring releases the energy such that the slider is moved to the other end of the slide board automatically when the slider is past the apex of the protrusion.

According to another preferred embodiment of the invention, the protrusion may be a sheet spring structure for enhancing the energy, which is stored first and then released to move the slider assembly. The slide board further includes a pair of sidewalls mounted on both sides of the slide board. Each of the sidewalls has a glide groove in which the protrusion is mounted. The roller is also mounted in the glide groove whereby the roller can be rolled on the inner surface of the protrusion.

In conclusion, the slider module according to the embodiments of the invention can enable an electrical apparatus that employs the slider module, such as a slide type mobile phone or a personal digital assistant, to be opened easily. In addition, an angle between a screen and a keyboard of the slide type mobile phone can suit a human face such that sound received by the slide type mobile phone is clear because the slider module can provide a flipping function. Moreover, the slider module according to the embodiments of the invention employs simple and cheap spring mechanisms to decrease the manufacturing cost such that the electrical apparatus that employs the slider module can be much more popularly applied.

It is to be understood that both the foregoing general description and the following detailed description are by examples and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1A is an exploded view of a slider module with a flipping function according to one preferred embodiment of this invention;

FIG. 1B is an exploded view of a slider assembly in the slider module of FIG. 1A;

FIG. 2A is a three dimensional view of a slide type mobile phone that employs the slider module of FIG. 1A in a closed state;

FIG. 2B is a three dimensional view of the slider module in the slide type mobile phone of FIG. 2A;

FIG. 2C is a side view of the slide type mobile phone of FIG. 2A;

FIG. 3A is a three dimensional view of the slide type mobile phone of FIG. 2A in a moving state;

FIG. 3B is a three dimensional view of the slider module in the slide type mobile phone of FIG. 3A;

FIG. 3C is a side view of the slide type mobile phone of FIG. 3A;

FIG. 4A is a three dimensional view of the slide type mobile phone of FIG. 2A in a opened state;

FIG. 4B is a three dimensional view of the slider module in the slide type mobile phone of FIG. 4A; and

FIG. 4C is a side view of the slide type mobile phone of FIG. 4A.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

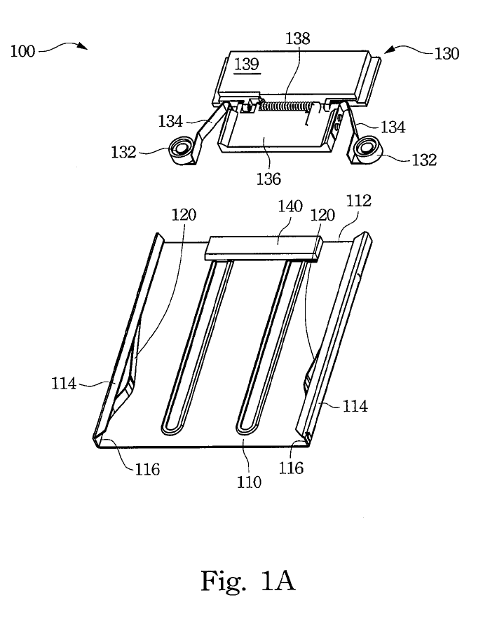

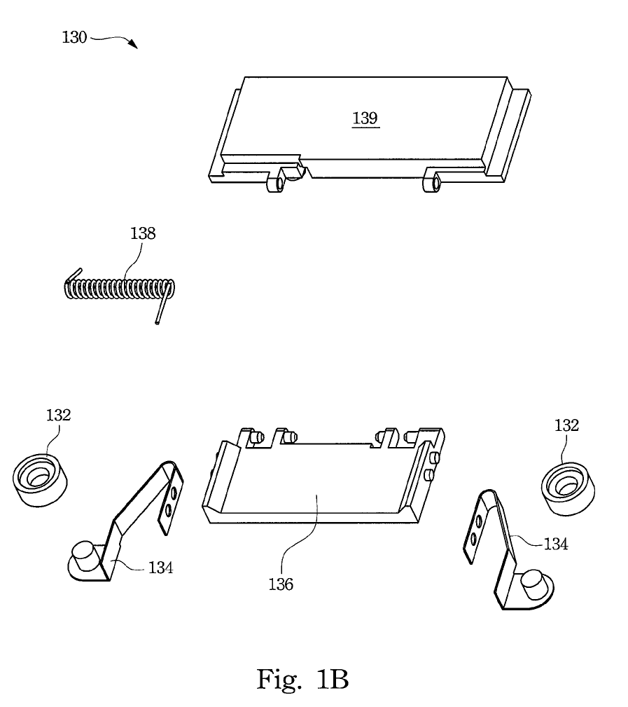

Reference is made to FIG. 1A, which is an exploded view of a slider module with a flipping function according to one preferred embodiment of this invention. In FIG. 1A, a slider module 100 with a flipping function including a slide board 110, an end stopper 140, at least one protrusion 120 and a slider assembly 130 is provided. The end stopper 140 is mounted on one end 112 of the slide board 110. The slider assembly 130 is coupled with the slide board 110. The protrusion 120 is mounted on the slide board 110. The end stopper 140 is a slab in FIG. 1A, but this does not limit the invention.

The slide board 110 further includes a pair of sidewalls 114 mounted on both sides of the slide board 110. Each of the sidewalls 114 has a glide groove 116 in which the protrusion 120 is mounted.

The protrusion 120 is a sheet spring structure in this embodiment and is V-shaped with its apex toward the inside of the slide board. However, the protrusion also may be a solid protrusion, a soft protrusion or a protrusion integrated with the slide board and may be any other shape.

Reference is made to FIG. 1B, which is an exploded view of the slider assembly in the slider module of FIG. 1A. The slider assembly 130 has at least one roller 132, at least one sheet spring 134, a slider 136, a rotation spring 138, and a rotation part 139. The roller 132 is positioned on the inner surface of the protrusion 120. The sheet spring 134 is mounted on the roller 132. The slider 136 is mounted on the sheet spring 134. The rotation spring 138 is mounted on the front end of the slider 136. The rotation part 139 is mounted on the rotation spring 138 such that the rotation part 139 can be rotated relative to the slider 136 automatically.

The roller 132 may be made of plastic, rubber or preferably metal. The sheet spring 134 may be made of any material that is springy, such as spring steel, alloy or other similar material.

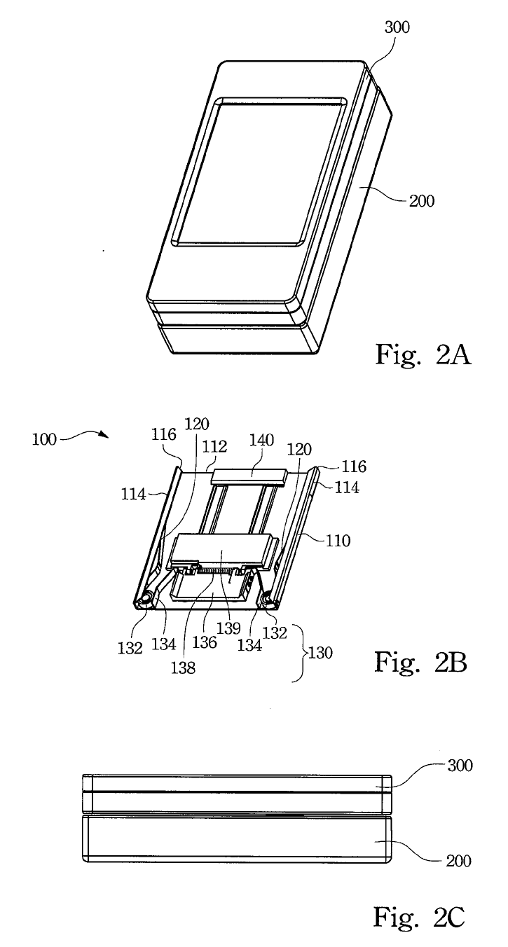

Reference is made to FIGS. 2A˜2C. FIG. 2A is a three dimensional view of a slide type mobile phone that employs the slider module of FIG. 1A in a closed state. FIG. 2B is a three dimensional view of the slider module in the slide type mobile phone of FIG. 2A. FIG. 2C is a side view of the slide type mobile phone of FIG. 2A. The slide type mobile phone has the slider module 100 of FIG. 1A, a base 200 and a screen 300. The slider module 100 is mounted in the base 200. The screen 300 is mounted on the rotation part 139.

The roller 132 is mounted in the glide groove 116, whereby the roller 132 can be rolled on the inner surface of the protrusion 120. When the screen 300 is pushed, the slider 136 is also pushed to the end 112 of the slide board 110 such that the roller 132 is moved to the apex of the protrusion 120, and thus the sheet spring 134 is deformed to store energy.

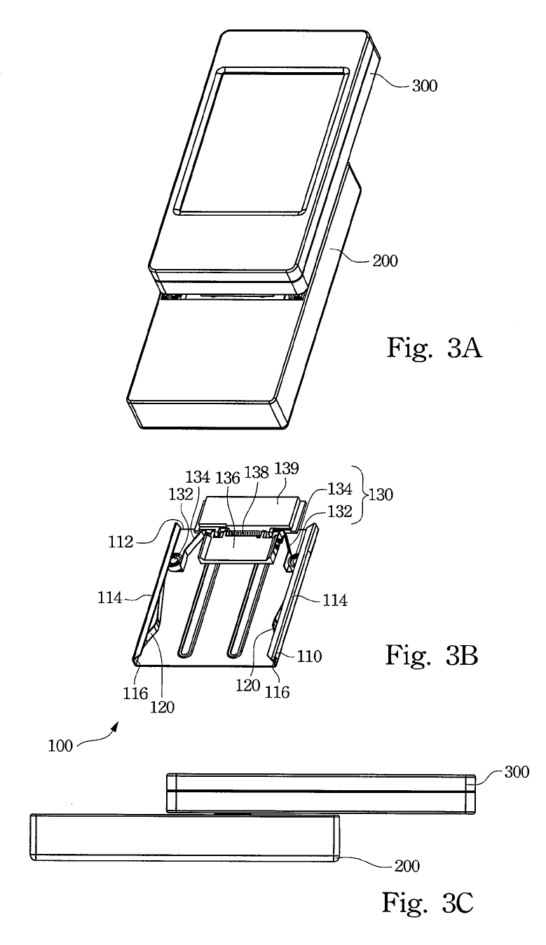

Reference is made to FIGS. 3A˜3C. FIG. 3A is a three dimensional view of the slide type mobile phone of FIG. 2A in a moving state. FIG. 3B is a three dimensional view of the slider module in the slide type mobile phone of FIG. 3A. FIG. 3C is a side view of the slide type mobile phone of FIG. 3A.

The sheet spring 134 releases the energy such that the slider 136 is moved to the end 112 of the slide board 110 automatically when the slider 136 is past the apex of the protrusion 120 in FIG. 3B. In FIGS. 3A and 3C, the screen 300 is moved relative to the base 200 automatically at this time.

The slide board 110 limits the rotation of the rotation part 139 when the slider assembly 130 slides along the slide board 110. Thus, in FIGS. 3A and 3C, an angle between the screen 300 and the base 200 of the slide type mobile phone is about 180°.

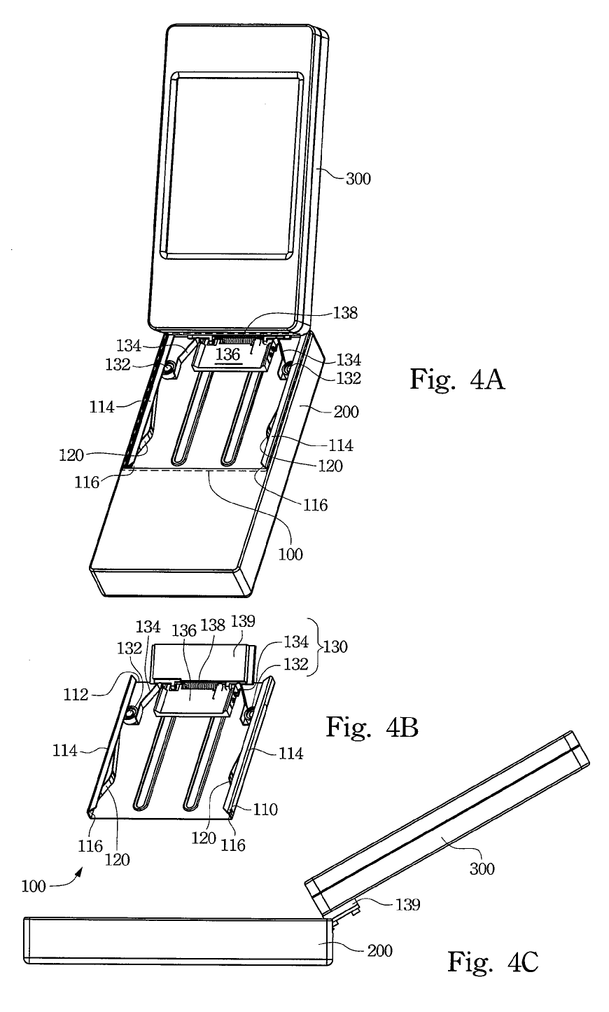

Reference is made to FIGS. 4A˜4C. FIG. 4A is a three dimensional view of the slide type mobile phone of FIG. 2A in an opened state. FIG. 4B is a three dimensional view of the slider module in the slide type mobile phone of FIG. 4A. FIG. 4C is a side view of the slide type mobile phone of FIG. 4A.

There is a space between the end stopper 140 and the top wall of the slide board 110. When the end stopper 140 stops the slider 136, the rotation part 139 is protruded from the slide board 110 through the space such that the rotation part 139 is rotated relative to the slider 136 automatically while not being limited by the slide board 110.

In FIGS. 4A and 4C, the angle between the screen 300 and the base 200 of the slide type mobile phone is smaller than 180°. Thus, the angle can be designed to suit a human face such that sound received by the slide type mobile phone is clear.

In conclusion, the slider module according to the embodiments of the invention has the advantages of:

(1) enabling an electrical apparatus that employs the slider module, such as a slide type mobile phone or a personal digital assistant, to be opened easily;

(2) enabling an angle between a screen and a keyboard of the slide type mobile phone to suit a human face such that sound received by the slide type mobile phone is clear because the slider module can provide a flipping function; and

(3) employing simple and cheap spring mechanisms to decrease the manufacturing cost such that the electrical apparatus that employs the slider module can be much more popularly applied.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A slider module comprising:
a slide board;
at least one protrusion mounted on the slide board; and
a slider assembly coupled with the slide board, the slider assembly comprising:
at least one roller positioned on the inner surface of the protrusion for enabling the slider assembly to slide along the slide board;
at least one sheet spring mounted on the roller; and
a slider mounted on the sheet spring whereby the roller is moved to the apex of the protrusion such that the sheet spring is deformed to store energy when the slider is pushed from one end of the slide board, and the sheet spring releases the energy such that the slider is moved to the other end of the slide board automatically when the slider is past the apex of the protrusion.

2. The slider module of claim 1, wherein the protrusion is a sheet spring structure.

3. The slider module of claim 2, wherein the shape of the sheet spring structure is V-shaped, and the apex of the sheet spring structure is toward the inside of the slide board.

4. The slider module of claim 1, wherein the slide board further comprises a pair of sidewalls, and each of the sidewalls comprises a glide groove.

5. The slider module of claim 4, wherein the protrusion is mounted in the glide groove.

6. The slider module of claim 5, wherein the protrusion is a sheet spring structure.

7. The slider module of claim 6, wherein the shape of the sheet spring structure is V-shaped, and the apex of the sheet spring structure is toward the inside of the slide board.

8. The slider module of claim 5, wherein the roller is positioned in the glide groove whereby the roller is able to be rolled on the inner surface of the protrusion.

9. A slider module with a flipping function, the slider module comprising:
a slide board;
a end stopper mounted on one end of the slide board;
at least one protrusion mounted on the slide board; and
a slider assembly coupled with the slide board, the slider assembly comprising:
at least one roller positioned on the inner surface of the protrusion for enabling the slider assembly to slide along the slide board;
at least one sheet spring mounted on the roller;
a slider mounted on the sheet spring whereby the roller is moved to the apex of the protrusion such that the sheet spring is deformed to store energy when the slider is pushed from the other end of the slide board, and the sheet spring releases the energy such that the slider is moved to the end stopper automatically and stopped by the end stopper when the slider is past the apex of the protrusion;
at least one rotation spring mounted on the front end of the slider; and
a rotation part mounted on the rotation spring whereby the rotation spring enables the rotation part to be rotated relative to the slider, and the rotation part is rotated relative to the slider while not limited by the slide board when the slider is stopped by the end stopper such that the rotation part is protruded from the slide board.

10. The slider module of claim 9, wherein the protrusion is a sheet spring structure.

11. The slider module of claim 10, wherein the shape of the sheet spring structure is V-shaped, and the apex of the sheet spring structure is toward the inside of the slide board.

12. The slider module of claim 9, wherein the slide board further comprises a pair of sidewalls, and each of the sidewalls comprises a glide groove.

13. The slider module of claim 12, wherein the protrusion is mounted in the glide groove.

14. The slider module of claim 13, wherein the protrusion is a sheet spring structure.

15. The slider module of claim 14, wherein the shape of the sheet spring structure is V-shaped, and the apex of the sheet spring structure is toward the inside of the slide board.

16. The slider module of claim 13, wherein the roller is positioned in the glide groove whereby the roller is able to be rolled on the inner surface of the protrusion.

17. The slider module of claim 9, wherein the end stopper is a slab.

18. The slider module of claim 17, wherein a vertical distance between the bottom of the rotation part and the bottom of the slider is larger than the vertical size of the slab.

19. The slider module of claim 9, wherein the roller is made of metal.
